(19) United States
(12) Patent Application Publication
(10) Pub. No.: US 2018/0191178 A1
(43) Pub. Date: Jul. 5, 2018

(54) FURNITURE WITH EMBEDDED WIRELESS POWER TRANSMISSION

(71) Applicants: Norman R. Byrne, Ada, MI (US); Daniel P. Byrne, Lowell, MI (US)

(72) Inventors: Norman R. Byrne, Ada, MI (US); Daniel P. Byrne, Lowell, MI (US)

(21) Appl. No.: 15/861,275

(22) Filed: Jan. 3, 2018

Related U.S. Application Data
(60) Provisional application No. 62/442,729, filed on Jan. 5, 2017.

(51) Int. Cl. H02J 7/00; A47C 17/86; H02J 7/02; H02J 50/12; H02J 50/80; H02J 5/00

(52) U.S. Cl. CPC H02J 7/0027; A47C 17/86; H02J 5/005; H02J 50/12; H02J 50/80; H02J 7/025

(57) ABSTRACT

A wireless electrical power system for a furniture article, includes a wireless electrical power transmitter and an electrical cord. The wireless electrical power transmitter is configured for mounting below a top support surface in an upper region of an upright arm of a furniture article such as a chair or sofa. The electrical cord has a proximal end coupled to the wireless electrical power transmitter and a distal end configured to extend downwardly through the upright arm and exit the furniture article for connection to an outside power source, such as a wall outlet. The wireless power transmitter is energizable by the outside power source to wirelessly convey electrical power to a portable electrical or electronic device having a wireless electrical power receiver and a rechargeable energy storage device, when the portable electrical or electronic device is supported at the top support surface of the upright arm.

### CROSS REFERENCE TO RELATED APPLICATION

The present application claims the benefit of U.S. provisional application Ser. No. 62/442,729, filed Jan. 5, 2017, which is hereby incorporated herein by reference in its entirety.

### FIELD OF THE INVENTION

The present invention relates to electrical power systems associated with furniture articles.

### BACKGROUND OF THE INVENTION

Portable electronic devices often require charging of their onboard batteries. However, in many circumstances the locations where compatible electrical power sources are available do not permit convenient access to the devices while they are charging. Due to limitations such as cord length, cord availability, and locations of outside power sources, it may not be feasible to charge a portable electronic device while keeping it in a location that is readily accessible to the device's user, who may wish to be seated at a furniture article such as a chair or sofa.

### SUMMARY OF THE INVENTION

The present invention provides an unobtrusive wireless electrical power system for convenient access by users seated at a furniture article, such as a chair or sofa. The electrical power system includes a wireless electrical power transmitter and an electrical cord for supplying power to the transmitter. The wireless electrical power transmitter is mountable inside an upright arm of a furniture article, such as below a top support surface in an upper region of the upright arm. The electrical cord connects to the wireless electrical power transmitter and extends downwardly through the arm, exiting the furniture article for connection to an outside power source, such as a wall outlet. The wireless power transmitter is energized by the outside power source to convey electrical power to a portable electrical or electronic device having a wireless electrical power receiver and a rechargeable battery or other energy storage device.

According to one form of the present invention, a furniture article with wireless electrical power transmission capability includes a seating surface, at least one upright arm coupled to the seating surface, and a wireless electrical power transmitter positioned in an upper region of the upright arm. The upright arm has a top support surface above the wireless power transmitter, which is in an upper region of the upright arm. A padding material is disposed between the top support surface and the wireless electrical power transmitter. An electrical cord is provided and is in communication with the wireless power transmitter and is configured to receive and convey power from an outside power source to the wireless power transmitter. The power transmitter is operable to wirelessly convey electrical power to a portable electrical or electronic device having a wireless electrical power receiver and a rechargeable energy storage device when a wireless power receiver associated with the portable electrical or electronic device is supported at the top support surface.

In one aspect, there are at least two upright arms including a first upright arm positioned at a first side of the seating surface and a second upright arm positioned at a second side of the seating surface. Each of the upright arms includes at least one of the wireless electrical power transmitters.

In another aspect, there is an electrical conductor extending between and operatively coupled to each of the wireless electrical power transmitters. The electrical conductor extends below the seating surface and is electrically energized by the outside power source via the electrical cord.

In yet another aspect, each of the upright arms includes at least two of the wireless electrical power transmitters in horizontally-spaced arrangement.

In a further aspect, the top support surface includes a sheet material, which is a continuous sheet extending over the wireless electrical power transmitter and further extending down along and below opposite sides of the wireless electrical power transmitter.

According to another form of the present invention, a furniture article with wireless electrical power transmission capability includes a seating surface, a pair of spaced-apart upright arms coupled to opposite sides of the seating surface, and at least two wireless electrical power transmitters positioned in horizontally-spaced relationship in respective upper regions of the upright arms. The upright arms each include an upholstery sheet material forming a top support surface of each arm. An electrical cord is in communication with each of the power transmitters and configured to receive and convey power from an outside power source, such as a wall or floor outlet, to both of the power transmitters in each arm. The power transmitters are each operable to wirelessly convey electrical power to a portable electrical or electronic device having a wireless electrical power receiver when the portable electrical or electronic device is supported at the top support surface within range of at least one of the transmitters. The upholstery sheet material is a continuous material extending over the at least two wireless electrical power transmitters in each of the upright arms. The continuous material further extends down along the respective upright arms and below opposite sides of the at least two wireless electrical power transmitters at each of the upright arms.

Optionally, at least a portion of each of the top support surfaces, directly above each of the wireless electrical power transmitters, is formed as a planar horizontal surface.

Therefore, the present invention provides users seated at or otherwise positioned at or near a furniture article with convenient access to electrical power and/or electronic data via one or more wireless power transmitters located beneath top surfaces of chair arms or the like. The electrical system may be plugged into an electrical power source for substantially continuous power, without requiring that an extension cord be draped over or in front of the furniture article.

These and other objects, advantages, purposes and features of the present invention will become apparent upon review of the following specification in conjunction with the drawings.

### BRIEF DESCRIPTION OF THE DRAWINGS

FIG. 1 is a front elevation of a sofa having wireless electrical power transmitters mounted in respective arms, in accordance with the present invention;

FIG. 2 is an enlarged perspective view of one sofa arm and two wireless electrical power transmitters in the arm;

FIG. 3 is a perspective view of a chair having wireless electrical power transmitters (not shown) in accordance with the present invention, and with an electrical outlet device supported on one of the chair arms; and

FIG. 4 is an enlarged perspective view of a portion of the chair arm and electrical outlet device mounted thereon.

### DESCRIPTION OF THE PREFERRED EMBODIMENTS

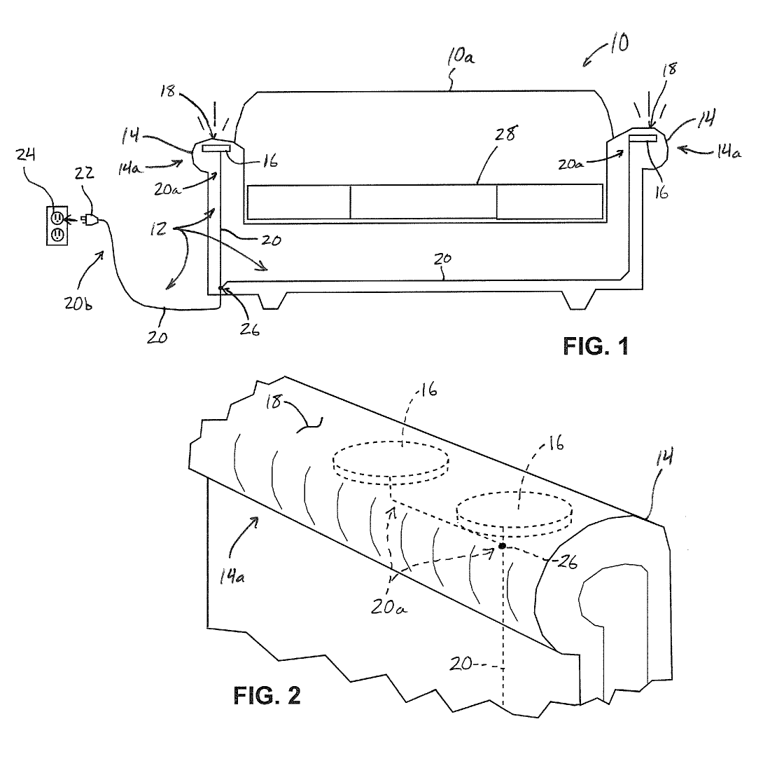

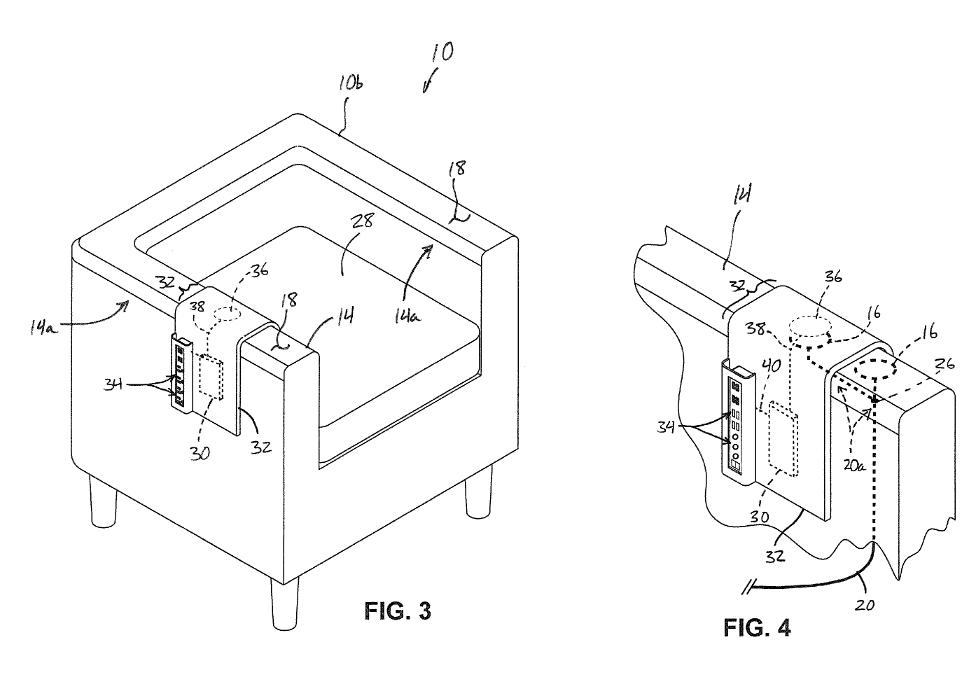

Referring now to the drawings and the illustrative embodiments depicted therein, a furniture article 10 with wireless electrical power system 12 provides for the wireless charging of portable electronic devices when the devices themselves, or an appropriate wireless receiver associated with a portable electronic device, is/are supported atop the furniture article 10. As shown in FIGS. 1 and 3, furniture article 10 may be a sofa 10a or a chair 10b, although it is envisioned that substantially any other article having an upright arm 14 or backrest or similarly-configured support. Electrical power system 12 includes at least one wireless electrical power transmitter 16 positioned in an upper region 14a of the upright arm 14, below a top support surface 18 that forms an uppermost surface of arm 14. Wireless electrical power transmitter 16 receives power from a power cord 20 having a proximal end portion 20a that is electrically coupled to transmitter 16. A distal end portion 20b of the power cord extends outwardly away from furniture article 10 and terminates at a plug 22 that is configured for engagement with an outside power source 24, such as a high voltage AC wall outlet (FIG. 1).

Wireless electrical power transmitters 16 may utilize substantially any appropriate wireless power transmission technology, such as electromagnetic field or magnetic resonance field induction, electric field resonant capacitive coupling, or direct-contact pads with “lanes” of electrical conductors carrying low voltage power at opposite polarities, for example. However, it will be appreciated that when non-contact wireless power transmission technology is utilized in transmitters 16, top support surface 18 can be made from fabric, wood, leather, resinous plastics, fiberglass-reinforced materials, or substantially any material that does not block wireless power transmission emitted by the particular type of technology embodied in transmitters 16. In order to support a portable electronic device at top support surface 18, it may be desirable to form at least a portion the top support surface 18, directly above each of the wireless electrical power transmitters 16, as a planar horizontal surface, or a concave-up surface.

Furniture article 10 may be upholstered in a conventional manner, including placing fabrics, leather, or other outer coverings, padding, etc. over the framework and over the wireless electrical power transmitter 16 and other components of the electrical system 12, without providing access panels or openings, or creating extra seams, for example. Optionally, the furniture covering material includes a continuous sheet or sheet section that extends over the wireless electrical power transmitter 16, and further extends down along and below opposite sides of the wireless electrical power transmitter, thus providing a clean uninterrupted appearance while also limiting or preventing access or tampering with the transmitter 16 by persons in the vicinity of the furniture article. It will be appreciated that by making wireless transmitter 16 invisible or highly unobtrusive, the aesthetics of the furniture article may be preserved while also reducing the likelihood of damage to the transmitter 16. Optionally, a liquid-impervious layer may be placed over the transmitter 16 to prevent damage from liquid spills onto top support surface 18.

In the illustrated embodiments, and as best shown in FIGS. 2 and 4, electrical power system 12 includes a single power cord 20 supplying electrical power to two wireless electrical power transmitters 16 in each arm 14. However, it is envisioned that substantially any number of transmitters 16 may be provided in any one or more arms 14 of a given furniture article 10, or in a backrest, for example. Optionally, one or more splice junctions or modular (i.e., plug-in) junctions 26 may be used to add additional wiring or cords for additional power transmitters, such as shown in FIGS. 1, 2 and 4.

Once energized by outside power source 24, wireless power transmitters 16 may be used to energize and/or recharge various types of portable electronic devices such as mobile phones, portable media players, tablet and laptop computers, and the like, once one or more of those portable electronic devices (not shown) are sufficiently aligned and placed within transmission range of one of the energized transmitters 16. Thus, a device user seated along a support surface 28 of the furniture article 10 may place a compatible wirelessly-rechargeable device directly atop the top support surface 18 of the upright arm 14, within viewing distance and reach of the user seated at the furniture 10.

Optionally, electrical power system 12 may be used to recharge an onboard battery 30 of a portable drape-over or hang-over article 32 that is configured to be supported at arm 14 of the furniture article 10, such as shown in FIGS. 3 and 4. Portable article 32 may be a rigid or flexible device that is readily placed along arm 14 for both recharging its onboard battery 30 and for energizing one or more electrical outlets 34, such as low voltage DC power outlets (e.g., USB-type, coaxial, etc.), that are supported by the portable article 32. Portable article 32 includes at least one wireless power receiver 36 at an upper region 32a that is configured to be supported directly above the top support surface 18 of upright arm 14.

Wireless power receiver 36 is electrically coupled to onboard battery 30 by a charging cord 38, and onboard battery 30 is further connected to the one or more electrical outlets 34 by an outlet cord 40, such as shown in FIG. 4. Optionally, a controller mounted in portable article 32 detects the presence of an energized power transmitter 16 that is in-range, and controls the flow of charging power to battery 30 while also controlling the output of electrical power to outlets 34, such as by de-energizing outlets 34 once the remaining energy within battery 30 is determined to have fallen below a predetermined threshold minimum value. When outlets 34 are energized, the outlets can energize any engaged plugs that are associated with portable electronic devices having charging wires. Additional features and details of the portable article 32 may be found in co-pending and commonly-owned U.S. patent application Ser. No. 15/858,386, was filed Dec. 29, 2017, which is hereby incorporated herein by reference in its entirety.

Thus, the furniture article and electrical power system of the present invention provides users with convenient access to wireless charging power for their compatible electrical or electronic devices. The portable electronic devices can remain within reach and within view of a seated user who is supported at the furniture article, which may be a chair, a sofa, or the like. Although it is envisioned that some form of visible indicia may be placed along top support surface 18 to indicate the presence and location of a wireless power transmitter 16, with optional lighting or other signaling provided to further indicate whether a given transmitter is energized, it is further envisioned that the appearance of upright arm 14 may otherwise be unaffected by the presence of electrical system 12 so that there is little to no appreciable effect on aesthetics of the furniture article 10 in which an electrical system 12 is installed.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. A furniture article with wireless electrical power transmission, comprising:
a seating surface;
at least one upright arm coupled to said seating surface, said upright arm having a top support surface;
a wireless electrical power transmitter disposed in an upper region of said upright arm below said top support surface;
padding material disposed between said top support surface and said wireless electrical power transmitter;
an electrical cord in communication with said power transmitter and configured to receive and convey power from an outside power source to said power transmitter;
wherein said power transmitter is operable to wirelessly convey electrical power to a portable electrical or electronic device having a wireless electrical power receiver and a rechargeable energy storage device when a wireless power receiver associated with the portable electrical or electronic device is supported at said top support surface.

2. The furniture article of claim 1, wherein said at least one upright arm comprises a first upright arm positioned at a first side of said seating surface and a second upright arm positioned at a second side of said seating surface, wherein each of said upright arms comprises at least one of said wireless electrical power transmitters.

3. The furniture article of claim 2, further comprising an electrical conductor extending between and operatively coupled to each of said wireless electrical power transmitters, wherein said electrical conductor extends below said seating surface and is electrically energized by the outside power source via said electrical cord.

4. The furniture article of claim 2, wherein each of said upright arms comprises at least two of said wireless electrical power transmitters in horizontally-spaced arrangement.

5. The furniture article of claim 1, wherein said top support surface comprises a sheet material, and wherein said sheet material is a continuous sheet extending over said wireless electrical power transmitter and further extending down along and below opposite sides of said wireless electrical power transmitter.

6. A furniture article with wireless electrical power transmission, comprising:
a seating surface;
a pair of upright arms coupled to said seating surface at opposite sides thereof, said upright arms each comprising an upholstery sheet material forming a top support surface;
at least two wireless electrical power transmitters disposed in horizontal spaced arrangement in an upper region of each of said upright arms and below said top support surfaces; and
an electrical cord in communication with each of said power transmitters and configured to receive and convey power from an outside power source to both of said power transmitters;
wherein said power transmitters are operable to wirelessly convey electrical power to a portable electrical or electronic device having a wireless electrical power receiver when the portable electrical or electronic device is supported at said top support surface; and
wherein said upholstery sheet material is a continuous material extending over said at least two wireless electrical power transmitters in each of said upright arms, said continuous material further extending down along respective ones of said upright arms and below opposite sides of said at least two wireless electrical power transmitters at each of said upright arms.

7. The furniture article of claim 6, wherein at least a portion of each of said top support surfaces, directly above each of said at least two wireless electrical power transmitters, comprises a planar horizontal surface.

8. The furniture article of claim 7, further comprising a padding material disposed between each of said top support surfaces and each of said wireless electrical power transmitters.
